(19) United States
(12) Patent Application Publication
(10) Pub. No.: US 2014/0292674 A1
(43) Pub. Date: Oct. 2, 2014

(54) MOBILE DEVICE AND METHOD OF OPERATING A MOBILE DEVICE

(71) Applicant: Samsung Display Co., Ltd., Yongin-City (KR)

(72) Inventors: Hyun-Jae Lee, Yongin-City (KR); Jung-Soo Rhee, Yongin-City (KR); Kyung-Hyun Ko, Yongin-City (KR); Kee-Hyun Nam, Yongin-City (KR)

(21) Appl. No.: 13/966,763

(22) Filed: Aug. 14, 2013

(30) Foreign Application Priority Data
Mar. 26, 2013 (KR) 10-2013-0032094

(51) Int. Cl. G09G 5/00; G06F 3/041; G06F 1/16

(52) U.S. Cl. CPC G09G 5/006; G06F 1/1652; G06F 3/041
USPC 345/173; 345/156

(57) ABSTRACT

A mobile device according to example embodiments includes a display device including a flat display region having a flat shape and a curved display region having a curved shape, the curved display region being integrally formed with the flat display region, a sensing unit configured to detect a physical state of the mobile device, a context determining unit configured to determine a current context of the mobile device based on the physical state detected by the sensing unit, and to select one of the flat display region and the curved display region to be activated based on the current context, and a display controller configured to activate the selected one of the flat display region and the curved display region.

### CLAIM OF PRIORITY

This application makes reference to, incorporates the same herein, and claims all benefits accruing under 35 U.S.C. §119 from an application earlier filed in the Korean Intellectual Property Office on 26 Mar. 2013 and there duly assigned Serial No. 10-2013-0032094.

### BACKGROUND OF THE INVENTION

1. Field of the Invention

Embodiments of the present invention relate to mobile devices, and more particularly, to mobile devices including flat display regions and curved display regions, and methods of operating the mobile devices.

2. Description of the Related Art

A flexible display device has been recently developed, and the flexible display device can be bent by using a flexible substrate or film made of a bendable material such as a plastic. Such a flexible display device has properties of thinness, lightness, impact resistance as well as flexibility, which may result in an infinite amount of applications in the future due to its high manufacturability. Further, various shapes or forms of mobile devices employing such flexible display devices have been recently researched and developed.

### SUMMARY OF THE INVENTION

Example embodiments provide a mobile device that selectively activates a flat display region or a curved display region according to a context.

Example embodiments provide a method of operating a mobile device that selectively activates a flat display region or a curved display region according to a context.

In accordance with one aspect of example embodiments, there is provided a mobile device including a display device including a flat display region having a flat shape and a curved display region having a curved shape, the curved display region being integrally formed with the flat display region, a sensing unit configured to detect a physical state of the mobile device, a context determining unit configured to determine a current context of the mobile device based on the physical state detected by the sensing unit, and to select one of the flat display region and the curved display region to be activated based on the current context, and a display controller configured to activate the selected one of the flat display region and the curved display region.

In example embodiments, the physical state detected by the sensing unit may include at least one of a posture, a position, an azimuth, a movement, incident light, a proximity of an object, an altitude and a motion of the mobile device.

In example embodiments, the sensing unit may include at least one of a gyroscope, a geo-magnetic sensor, an accelerometer sensor, a gravity sensor, a light sensor, a proximity sensor, an altimeter, a motion recognition sensor, a digital compass, a camera and a touch sensor.

In example embodiments, the context determining unit may include a sensing result storing unit configured to receive a sensing result from at least one sensor included in the sensing unit, and to store the sensing result as the physical state, a context table configured to store a plurality of contexts respectively corresponding to a plurality of sensing results, and a display region selecting unit configured to select the current context corresponding to the sensing result stored in the sensing result storing unit among the plurality of contexts stored in the context table, and to select the one of the flat display region and the curved display region to be activated based on the current context.

In example embodiments, the display region selecting unit may be further configured to receive a logical state of the mobile device from an application processor included in the mobile device, and to select the one of the flat display region and the curved display region to be activated based on the current context and the logical state.

In example embodiments, the logical state of the mobile device may include at least one of an operating mode, an execution of an application and an occurrence of an event of the mobile device.

In example embodiments, the display region selecting unit may be further configured to receive a user setting, and to select the one of the flat display region and the curved display region to be activated based on the current context, the logical state and the user setting.

In example embodiments, the user setting may include an automatic selection or a manual selection for the one of the flat display region and the curved display region to be activated.

In example embodiments, when the sensing unit detects, as the physical state of the mobile device, that the mobile device is vertically disposed and that a proximity of an object is sensed at the flat display region, the context determining unit may determine, as the current context of the mobile device, that the mobile device is disposed in a pocket of a dress shirt, and may select the curved display region as a display region to be activated.

In example embodiments, when the sensing unit detects, as the physical state of the mobile device, that the mobile device is horizontally disposed and that the mobile device is not moving, the context determining unit may determine, as the current context of the mobile device, that the mobile device is disposed on a table, and may select the flat display region as a display region to be activated.

In example embodiments, wherein the display controller may control the display device to operate the selected one of the flat display region and the curved display region in an activate mode and to operate the other one of the flat display region and the curved display region in a sleep mode.

In example embodiments, a curvature of the curved display region may be adjusted according to a user setting.

In example embodiments, a ratio of a size of the flat display region to a size of the curved display region may be adjusted according to a user setting.

In accordance with another aspect of example embodiments, there is provided a method of operating a mobile device including a display device. The display device includes a flat display region having a flat shape and a curved display region having a curved shape, and the curved display region is integrally formed with the flat display region. In the method, a physical state of the mobile device is detected, a current context of the mobile device is determined based on the detected physical state, and one of the flat display region and the curved display region is selectively activated based on the current context.

In example embodiments, a logical state of the mobile device may be determined, and selectively activating the one of the flat display region and the curved display region may be performed based on the current context and the logical state.

In example embodiments, a user setting of the mobile device may be received, and selectively activating the one of the flat display region and the curved display region may be performed based on the current context, the logical state and the user setting.

In example embodiments, when that the mobile device is vertically disposed and that a proximity of an object is sensed at the flat display region are detected as the physical state of the mobile device, that the mobile device is disposed in a pocket of a dress shirt may be determined as the current context of the mobile device, and the curved display region may be activated.

In example embodiments, when that the mobile device is horizontally disposed and that the mobile device is not moving are detected as the physical state of the mobile device, that the mobile device is disposed on a table may be determined as the current context of the mobile device, and the flat display region may be activated.

In example embodiments, to selectively activate the one of the flat display region and the curved display region based on the current context, the one of the flat display region and the curved display region to be activated may be selected based on the current context, the selected one of the flat display region and the curved display region may be operated in an activate mode, and the other one of the flat display region and the curved display region may be operated in a sleep mode.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram illustrating a mobile device in accordance with example embodiments;

FIG. 2A is a perspective view of an example of a mobile device in accordance with example embodiments;

FIG. 2B is a cross-sectional view of an example of a mobile device in accordance with example embodiments taken along line II-IF of FIG. 2A;

FIG. 3 is a block diagram illustrating an example of a sensing unit included in a mobile device of FIG. 1;

FIG. 4 is a block diagram illustrating an example of a context determining unit included in a mobile device of FIG. 1;

FIG. 5 is a diagram illustrating an example of a context table included in a context determining unit of FIG. 4;

FIG. 6 is a diagram illustrating an example of a context where a mobile device is disposed in a pocket of a dress shirt;

FIG. 7 is a diagram illustrating an example of a context where a mobile device is disposed on a table;

FIG. 8 is a flowchart illustrating a method of operating a mobile device in accordance with example embodiments;

FIG. 9 is a diagram for describing a user interface of a mobile device in accordance with example embodiments;

FIG. 10 is a diagram for describing an example of a user interface of a mobile device in accordance with example embodiments; and

FIG. 11 is a diagram for describing another example of a user interface of a mobile device in accordance with example embodiments.

### DETAILED DESCRIPTION OF THE INVENTION

The example embodiments are described more fully hereinafter with reference to the accompanying drawings. The inventive concept may, however, be embodied in many different forms and should not be construed as limited to the example embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like or similar reference numerals refer to like or similar elements throughout. As used herein, the term “and/or” includes any and all combinations of one or more of the associated listed items.

It will be understood that, although the terms first, second, third etc. may be used herein to describe various elements, components, regions, layers, patterns and/or sections, these elements, components, regions, layers, patterns and/or sections should not be limited by these terms. These terms are only used to distinguish one element, component, region, layer pattern or section from another region, layer, pattern or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross sectional illustrations that are schematic illustrations of illustratively idealized example embodiments (and intermediate structures) of the inventive concept. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

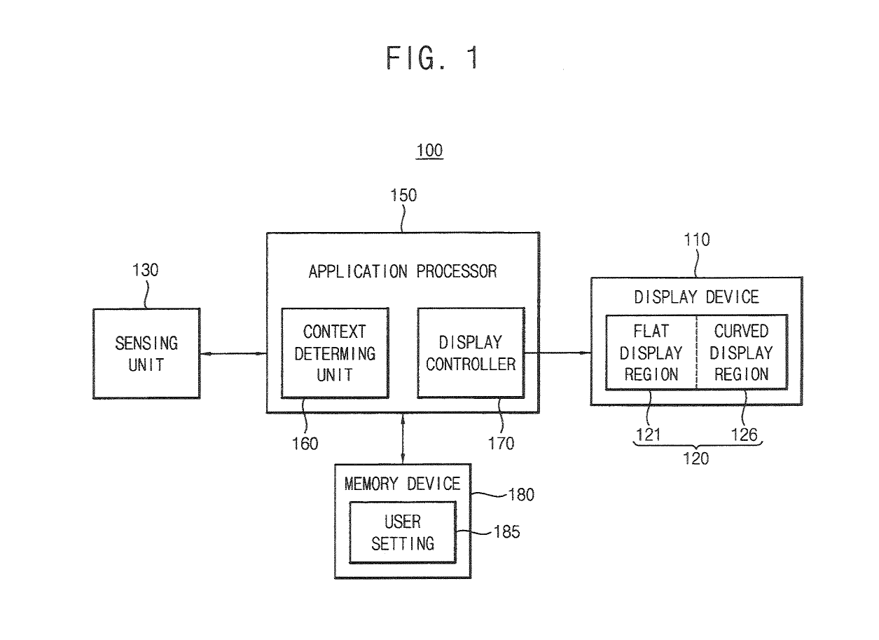

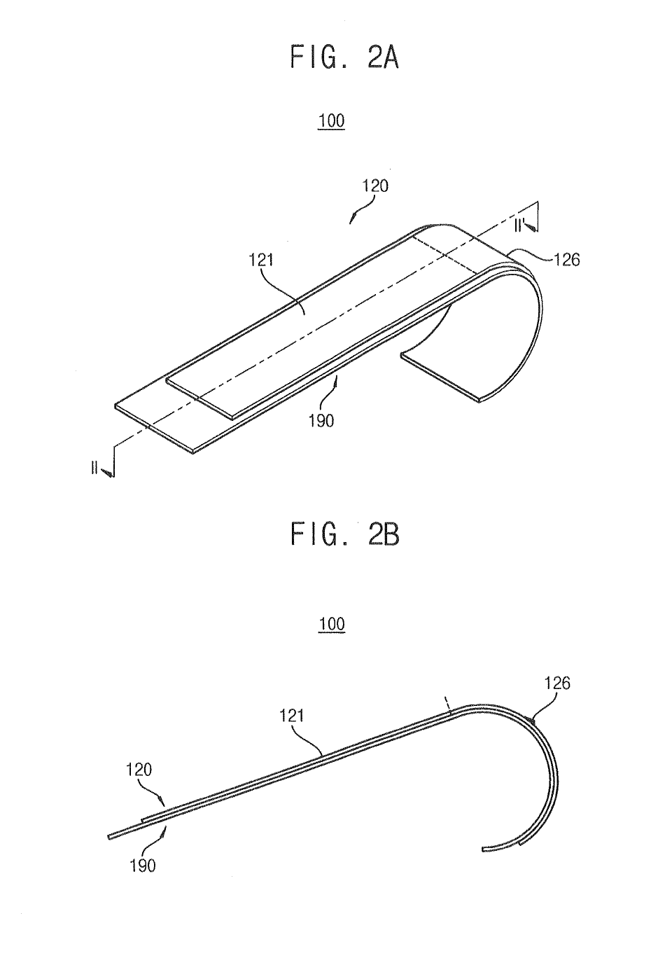

FIG. 1 is a block diagram illustrating a mobile device in accordance with example embodiments, FIG. 2A is a perspective view of an example of a mobile device in accordance with example embodiments, and FIG. 2B is a cross-sectional view of an example of a mobile device in accordance with example embodiments taken along line II-IF of FIG. 2A.

In reference to FIG. 1, a mobile device 100 includes a display device 110, a sensing unit 130, an application processor 150 and a memory device 180.

The display device 110 may include a flat display region 121 having a flat shape and a curved display region 126 having a curved shape. The flat display region 121 and the curved display region 126 may be integrally formed. That is, the flat display region 121 and the curved display region 126 may be physically one display region 120.

For example, as illustrated in FIGS. 2A and 2B, the display region 120 of the display device 110 may be formed on a predetermined substrate 190. The display region 120 may be divided into the flat display region 121 and the curved display region 126. The flat display region 121 may be substantially flat, and the curved display region 126 may be substantially bent or curved with a predetermined curvature. In some example embodiments, the curved display region 126 may have a fixed curvature. In other example embodiments, the curvature of the curved display region 126 may be adjusted according to a user setting. For example, a user may set the curvature of the curved display region 126 using an environment setting program or a user application program, and the mobile device 100 may change the curvature of the curved display region 126 to the set curvature.

In some example embodiments, a size of the flat display region 121 and a size of the curved display region 126 may be fixed. In other example embodiments, a ratio of the size of the flat display region 121 to the size of the curved display region 126 may be adjusted according to a user setting. For example, the user may set the size ratio using the environment setting program or the user application program, and the mobile device 100 may change the ratio of the size of the flat display region 121 to the size of the curved display region 126 to the set size ratio. Unlike a contemporary display device where display regions are separately formed and then are joined together, the display device 110 may use one physical display region 120 that is logically divided into the flat display region 121 and the curved display region 126, and may dynamically adjust the ratio of the size of the flat display region 121 to the size of the curved display region 126. Further, other components of the mobile device 100, such as the sensing unit 130, the application processor 150, the memory device 180, etc. may be formed on the substrate 190.

The sensing unit 130 may detect a physical state of the mobile device 100. For example, the sensing unit 130 may detect at least one of a posture, a position, an azimuth, a movement, incident light, a proximity of an object, an altitude and a motion of the mobile device as the physical state. In some example embodiments, to detect the physical state, the sensing unit 130 may include at least one of a gyroscope, a geo-magnetic sensor, an accelerometer sensor, a gravity sensor, a light sensor, a proximity sensor, an altimeter, a motion recognition sensor, a digital compass, a camera and a touch sensor.

The application processor 150 may perform various computing functions or tasks. The application processor 150 may be for example, a mobile system-on-chip (SOC), a microprocessor, a central processing unit (CPU), etc. The application processor 150 may control other components of the mobile device 100 via a bus. The application processor 150 may include a context determining unit 160 and a display controller 170. In some example embodiments, the application processor 150 may further include a power management unit for managing a power state of the application processor 150, a connectivity unit for providing various interfaces, etc.

The memory device 180 may store data for operations of the mobile device 100. For example, the memory device 180 may include at least one volatile memory device such as a dynamic random access memory (DRAM) device, a static random access memory (SRAM) device, a mobile dynamic random access memory (mobile DRAM) device, etc. and/or at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc.

The context determining unit 160 may determine a current context of the mobile device 100 based on the physical state detected by the sensing unit 130. In some example embodiments, to determine the current context, the context determining unit 160 may use a context table in which a plurality of contexts respectively corresponding to a plurality of sensing results of the sensing unit 130 are prestored. For example, the context determining unit 160 may receive, as the physical state, a sensing result from at least one sensor included in the sensing unit 130, and may obtain the current context corresponding to the received sensing result from the context table.

The context determining unit 160 may select one of the flat display region 121 and the curved display region 126 to be activated based on the current context. For example, in a case where the sensing unit 130 detects, as the physical state of the mobile device 100, that the mobile device 100 is vertically disposed and that a proximity of an object is sensed at the flat display region 121, the context determining unit 160 may determine, as the current context of the mobile device 100, that the mobile device 100 is disposed in a pocket of a dress shirt, and may select the curved display region 126 as a display region to be activated. In another example, in a case where the sensing unit 130 detects, as the physical state of the mobile device 100, that the mobile device 100 is horizontally disposed and that the mobile device 100 is not moving, the context determining unit 160 may determine, as the current context of the mobile device 100, that the mobile device 100 is disposed on a table, and may select the flat display region 121 as a display region to be activated.

In some example embodiments, the context determining unit 160 may receive a logical state of the mobile device 100 from the application processor 150, and may select the one of the flat display region 121 and the curved display region 126 to be activated based on the received logical state as well as the current context. Here, the logical state of the mobile device 100 may include at least one of an operating mode, an execution of an application and an occurrence of an event of the mobile device 100. For example, in a case where the context determining unit 160 receives an occurrence of an event (e.g., a reception of a call connection request, a reception of a text message, etc.) as the logical state, where the context determining unit 160 may perform the determination of the current context and/or the selection of the display region to be activated in response to the received logical state.

In other example embodiments, the context determining unit 160 may further receive a user setting, and may select the one of the flat display region and the curved display region to be activated based on the received user setting as well as the current context and the logical state. For example, a user setting 185 representing one of an automatic selection and a manual selection for the display region to be activated may be stored in the memory device 180, and the context determining unit 160 may receive the user setting 185 from the memory device 180. In a case where the user setting 185 indicates the automatic selection, the context determining unit 160 may automatically select the display region to be activated based on the current context and the logical state. In a case where the user setting 185 indicates the manual selection of the curved display region 126, the context determining unit 160 may select the curved display region 126 as the display region to be activated regardless of the current context and the logical state.

According to example embodiments, the context determining unit 160 may be implemented in software, hardware, or a combination thereof. For example, the context determining unit 160 may be implemented as an environmental setting program, a user application program, a bundle program (or a bearer) embedded in an operating system (OS), etc. Although FIG. 1 illustrates an example where the context determining unit 160 is located inside the application processor 150, in some example embodiments, at least a portion of the context determining unit 160 may be located outside the application processor 150.

The display controller 170 may control the display device 110. For example, the display controller 170 may control the display device 110 using at least one of various interfaces, such as a digital visual interface (DVI), a high definition multimedia interface (HDMI), a mobile industry processor interface (MIPI), a DisplayPort, or the like. The display controller 170 may activate the one of the flat display region 121 and the curved display region 126 that is selected by the context determining unit 160. For example, the display controller 170 may control the display device 110 to operate the selected one of the flat display region 121 and the curved display region 126 in an activate mode and to operate the other one of the flat display region 121 and the curved display region 126 in a sleep mode. Accordingly, the display device 110 may operate one of the flat display region 121 and the curved display region 126 that is suitable for the current context, thereby providing user convenience and reducing power consumption.

As described above, the mobile device 100 according to example embodiments may include the flat display region 121 and the curved display region 126 that are integrally formed, and may selectively activate one of the flat display region 121 and the curved display region 126 according to the current context of the mobile device 100. In one embodiment, the flat display region 121 and the curved display region 126 may be formed simultaneously together as a single integral and monolithic and continuous structure. Since one of the display regions 121 and 126 suitable for the current context is activated, the mobile device 100 according to example embodiments may provide user convenience by automatically activating the desired display region, and may reduce power consumption by deactivating an undesired display region.

Although it is not illustrated in FIG. 1, in some example embodiments, the mobile device 100 may further include a modem, such as a baseband chipset, for communicating with an external device, a power supply for providing power, at least one input device such as a button, at least one output device such as a speaker, a storage device, such as a memory card, a solid state drive (SSD), etc., a camera image processor (CIS), or the like.

The mobile device 100 and/or components of the mobile device 100 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP).

According to example embodiments, the mobile device 100 may be any electronic device including the display device 110, such as a mobile phone, a smart phone, a laptop computer, a tablet computer, a personal digital assistants (PDA), a portable multimedia player (PMP), a digital camera, a music player, a portable game console, a navigation device, etc.

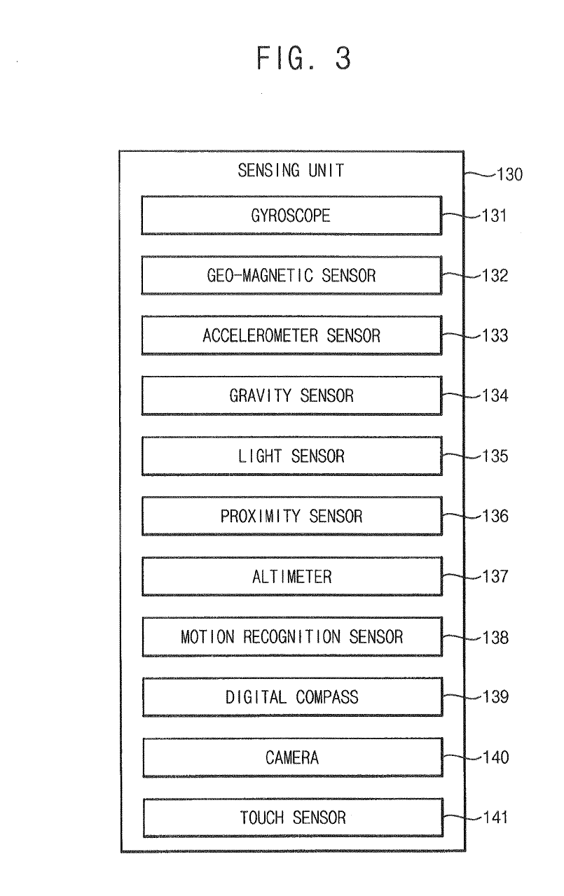

FIG. 3 is a block diagram illustrating an example of a sensing unit included in a mobile device of FIG. 1.

In reference to FIG. 3, a sensing unit 130 may include at least one of a gyroscope 131, a geo-magnetic sensor 132, an accelerometer sensor 133, a gravity sensor 134, a light sensor 135, a proximity sensor 136, an altimeter 137, a motion recognition sensor 138, a digital compass 139, a camera 140 and a touch sensor 141.

The gyroscope 131 may measure not only a movement of the mobile device in a linear direction but also a movement of a mobile device in a circular direction by detecting a rotational inertia, and thus may more accurately detect the movement of the mobile device. The accelerometer sensor 133 may measure acceleration or intensity of impact of the mobile device. The gravity sensor 134 may sense in which direction the force of gravity acts on the mobile device. In some example embodiments, the mobile device may detect whether the mobile device is vertically or horizontally disposed by using the gyroscope 131, the accelerometer sensor 133 and/or the accelerometer sensor 133. Further, the mobile device may detect whether a user possessing the mobile device is moving or not moving by using the gyroscope 131, the accelerometer sensor 133 and/or the accelerometer sensor 133.

The light sensor 135 may measure intensity of incident light or ambient light, which may be referred to as an illumination sensor. The proximity sensor 136 may detect whether an object approaches the mobile device. For example, the proximity sensor 136 may be divided into a high-frequency oscillation-type proximity sensor, a capacitive proximity sensor, a magnetic proximity sensor, a photoelectric proximity sensor, an ultrasonic proximity sensor, etc. according to a principle of detection. The altimeter 137 may serve as a barometer that measures atmospheric pressure, and may determine an altitude corresponding to the measured atmospheric pressure. In some example embodiments, the mobile device may detect where the mobile device is disposed by using the light sensor 135, the proximity sensor 136 and/or the altimeter 137 as well as the gyroscope 131, the accelerometer sensor 133 and/or the accelerometer sensor 133.

The geo-magnetic sensor 132 and/or the digital compass 139 may serve as an electronic compass that detects an azimuth using the earth's magnetic field. In some example embodiments, the mobile device may detect which place on a map the user possessing the mobile device moves toward by using the geo-magnetic sensor 132 and/or the digital compass 139.

The motion recognition sensor 138 may sense a movement or a position of the mobile device. The motion recognition sensor 138 may be an integrated sensor where functions of the gyroscope 131, the geo-magnetic sensor 132, the accelerometer sensor 133 and the altimeter 137 are integrated. The camera 140 may capture a picture or an image. In some example embodiments, the mobile device may detect a motion of the mobile device or a gesture of the user by using the motion recognition sensor 138 and/or the camera 140.

The touch sensor 141 may sense a touch input by the user. The touch sensor 141 may be formed on the display region 120 of the display device 110 illustrated in FIG. 1. In some example embodiments, in a case where one of the flat display region 121 and the curved display region 126 illustrated in FIG. 1 is activated, and the other one of the flat display region 121 and the curved display region 126 illustrated in FIG. 1 is deactivated, the touch sensor 141 on the activated display region may be activated, and the touch sensor 141 on the deactivated display region may be deactivated.

Although FIG. 3 illustrates various exemplary sensors included in the sensing unit 130, according to example embodiments, the sensing unit 130 may include a portion or all of the sensors, or may further include other sensors.

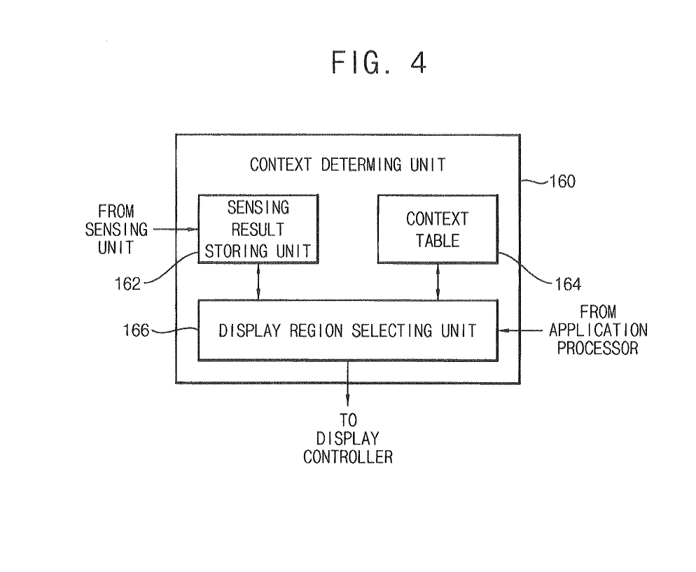

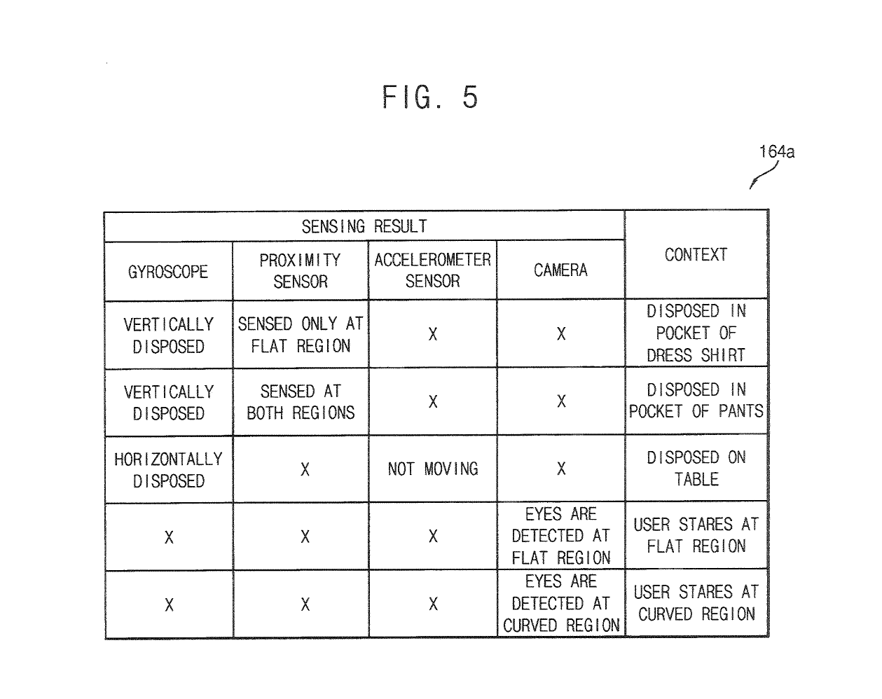

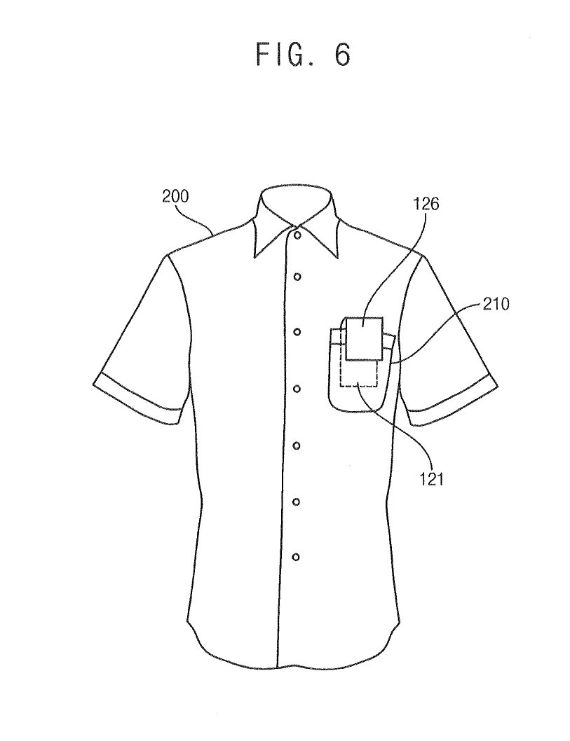

FIG. 4 is a block diagram illustrating an example of a context determining unit included in a mobile device of FIG. 1, FIG. 5 is a diagram illustrating an example of a context table included in a context determining unit of FIG. 4, FIG. 6 is a diagram illustrating an example of a context where a mobile device is disposed in a pocket of a dress shirt, and FIG. 7 is a diagram illustrating an example of a context where a mobile device is disposed on a table.

In reference to FIG. 4, a context determining unit 160 may include a sensing result storing unit 162, a context table 164 and a display region selecting unit 166.

The sensing result storing unit 162 may receive a sensing result from at least one sensor included in a sensing unit, and may store the received sensing result as a physical state of a mobile device. For example, the sensing result storing unit 162 may receive and store sensing results from a plurality of sensors included in the sensing unit with the same period or with different periods, and may provide the display region selecting unit 166 with the currently stored sensing results as the physical state of the mobile device. The sensing result stored in the sensing result storing unit 162 may be a measured value from each sensor, or may be physical information determined based on the measured value.

The context table 164 may store a plurality of contexts respectively corresponding to a plurality of sensing results. In some example embodiments, the plurality of contexts may be prestored in the context table 164 when the mobile device is manufactured. In other example embodiments, the plurality of contexts may be stored or updated in the context table 164 by a user setting. In still other example embodiments, the plurality of contexts may be adaptively stored or updated in the context table 164 by training a user's use habit.

The display region selecting unit 166 may receive the currently stored sensing result from the sensing result storing unit 162, and may select a current context of the mobile device corresponding to the received sensing result among the plurality of contexts stored in the context table 164 to determine the current context of the mobile device. The display region selecting unit 166 may select one of a flat display region and a curved display region to be activated based on the current context.

For example, in a case where a sensing result from a gyroscope indicates that the mobile device is vertically disposed and a sensing result from a proximity sensor indicates that a proximity of an object is sensed at the flat display region as illustrated in a first row of the context table 164a of FIG. 5, the display region selecting unit 166 may determine, as the current context, that the mobile device is disposed in a pocket 210 of a dress shirt 200 as illustrated in FIG. 6. In this case, the display region selecting unit 166 may select the curved display region 126 as the display region to be activated among the flat display region 121 and the curved display region 126.

In a case where a sensing result from the gyroscope indicates that the mobile device is vertically disposed and a sensing result from the proximity sensor indicates that a proximity of an object is sensed at both of the flat and curved display regions as illustrated in a second row of the context table 164a of FIG. 5, the display region selecting unit 166 may determine, as the current context, that the mobile device is disposed in a pocket of pants. In this case, the display region selecting unit 166 may select none of the flat and curved display regions to deactivate both of the flat and curved display regions.

In a case where a sensing result from the gyroscope indicates that the mobile device is horizontally disposed and a sensing result from an accelerometer sensor indicates that the mobile device is not moving as illustrated in a third row of the context table 164a of FIG. 5, the display region selecting unit 166 may determine, as the current context, that the mobile device is disposed on a table 220 as illustrated in FIG. 7. In this case, the display region selecting unit 166 may select the flat display region 121 as the display region to be activated among the flat display region 121 and the curved display region 126.

In a case where a sensing result from a camera indicates that eyes are detected at the flat display region as illustrated in a fourth row of the context table 164a of FIG. 5, the display region selecting unit 166 may determine, as the current context, that a user stares at the flat display region. In this case, the display region selecting unit 166 may select the flat display region. Further, in a case where a sensing result from the camera indicates that eyes are detected at the curved display region as illustrated in a fifth row of the context table 164a of FIG. 5, the display region selecting unit 166 may determine, as the current context, that a user stares at the curved display region. In this case, the display region selecting unit 166 may select the curved display region.

In some example embodiments, the display region selecting unit 166 may further receive a logical state of the mobile device from an application processor included in the mobile device, and may select the one of the flat display region and the curved display region to be activated based on the received logical state as well as the current context. For example, the logical state of the mobile device may include at least one of an operating mode, an execution of an application and an occurrence of an event of the mobile device.

In other example embodiments, the display region selecting unit 166 may further receive a user setting, and may select the one of the flat display region and the curved display region to be activated based on the received user setting as well as the current context and the logical state. For example, the user setting may include an automatic selection or a manual selection for the display region to be activated.

As described above, the context determining unit 160 included in the mobile device may determine the current context of the mobile device, and the flat display region or the curved display region may be selectively activated according to the current context, thereby providing user convenience and reducing power consumption.

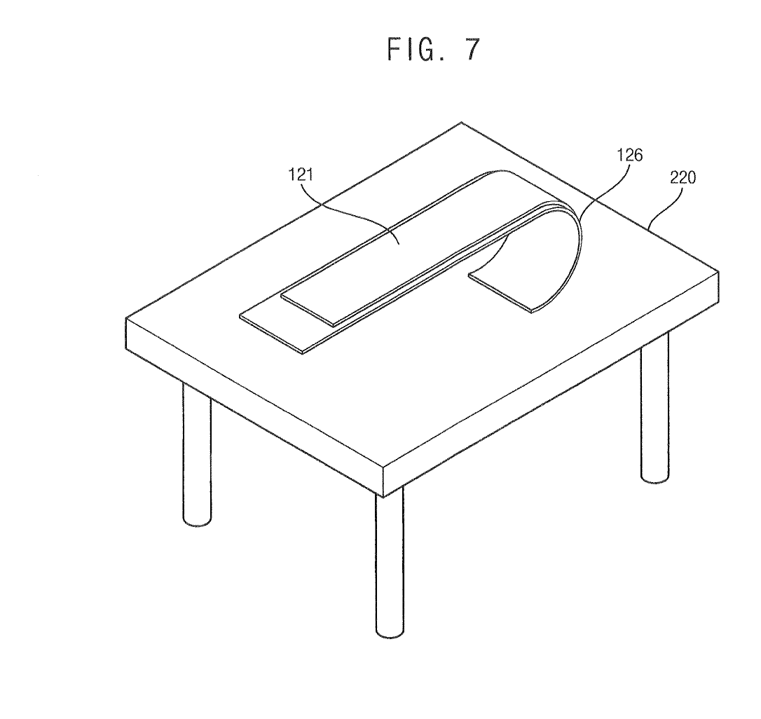

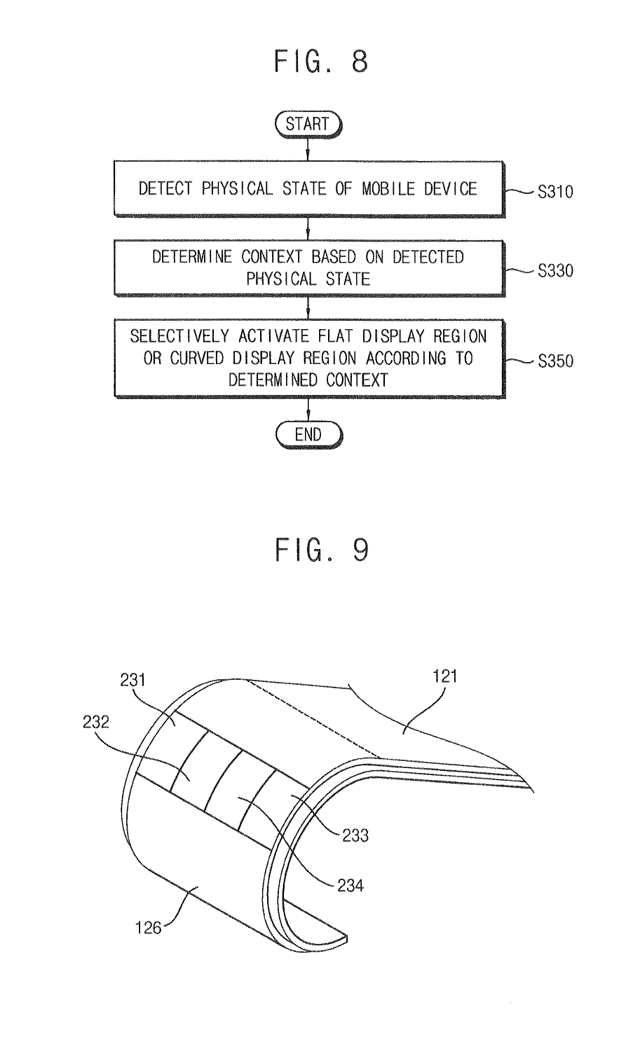

FIG. 8 is a flowchart illustrating a method of operating a mobile device in accordance with example embodiments.

In reference to FIGS. 1 and 8, in a method of operating a mobile device 100 including a display device 110 having a flat display region 121 and a curved display region 126 that are integrally formed, a sensing unit 130 may detect a physical state of the mobile device 100 (S310). For example, the sensing unit 130 may detect at least one of a posture, a position, an azimuth, a movement, incident light, a proximity of an object, an altitude and a motion of the mobile device 100.

A context determining unit 160 may determine a current context of the mobile device 100 based on the physical state detected by the sensing unit 130 (S330). For example, in a case where the sensing unit 130 detects, as the physical state of the mobile device 100, that the mobile device 100 is vertically disposed and that a proximity of an object is sensed at the flat display region 121, the context determining unit 160 may determine, as the current context of the mobile device 100, that the mobile device 100 is disposed in a pocket of a dress shirt. In another example, in a case where the sensing unit 130 detects, as the physical state of the mobile device 100, that the mobile device 100 is horizontally disposed and that the mobile device 100 is not moving, the context determining unit 160 may determine, as the current context of the mobile device 100, that the mobile device 100 is disposed on a table.

The display device 110 may selectively activate the flat display region 121 or the curved display region 126 according to the determined current context (S350). For example, the context determining unit 160 may select one of the flat display region 121 and the curved display region 126 to be activated based on the current context, and a display controller 170 may control the display device 110 to activated the selected display region. For example, in a case where the context determining unit 160 determines, as the current context of the mobile device 100, that the mobile device 100 is disposed in the pocket of the dress shirt, the display device 110 may activate the curved display region 126. In another example, in a case where the context determining unit 160 determines, as the current context of the mobile device 100, that the mobile device 100 is disposed on the table, the display device 110 may activate the flat display region 121. In some example embodiments, the display device 110 may operate the selected one of the flat display region 121 and the curved display region 126 in an activate mode, and may operate the other one of the flat display region 121 and the curved display region 126 in a sleep mode.

In some example embodiments, a logical state of the mobile device 100 may be further detected, and the selection of the display region to be activated may be performed based on the current context and the logical state. In other example embodiments, the selection of the display region to be activated may be performed based on the current context, the logical state and a user setting.

As described above, in a method of operating the mobile device 100 including the flat display region 121 and the curved display region 126 according to example embodiments, the flat display region 121 or the curved display region 126 may be selectively activated according to the current context of the mobile device 100. Accordingly, user convenience may be provided, and power consumption may be reduced.

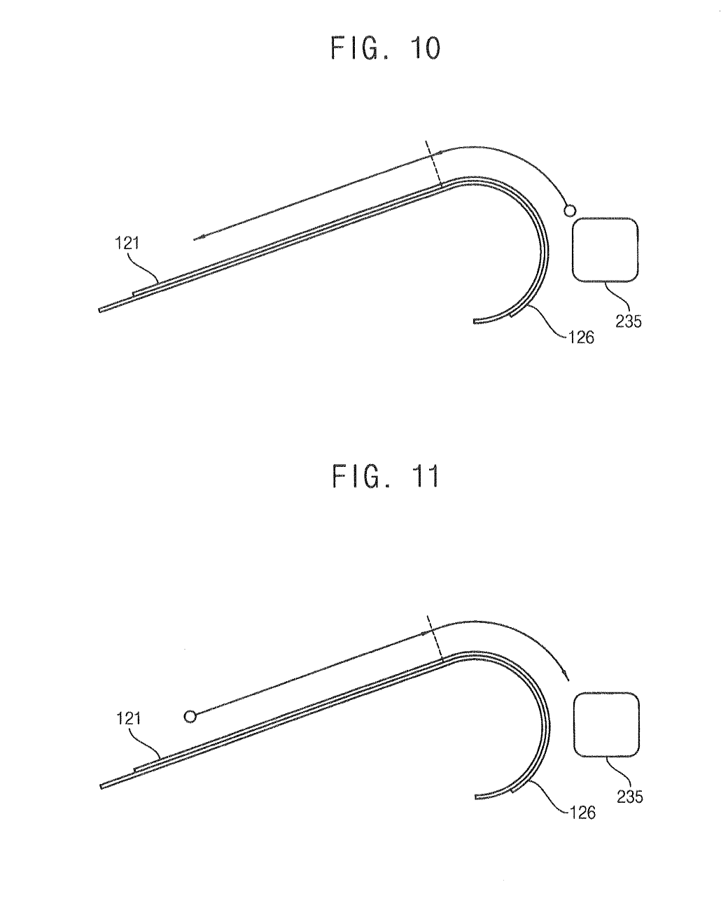

FIG. 9 is a diagram for describing a user interface of a mobile device in accordance with example embodiments, FIG. 10 is a diagram for describing an example of a user interface of a mobile device in accordance with example embodiments, and FIG. 11 is a diagram for describing another example of a user interface of a mobile device in accordance with example embodiments.

In some example embodiments, in reference to FIG. 9, in a mobile device including a flat display region and a curved display region 126 that are integrally formed, predetermined icons 231, 232, 233 and 234 may be displayed at the curved display region 126. In other example embodiments, the mobile device may dynamically switch the display region at which the predetermined icons 231, 232, 233 and 234 are displayed to the flat display region or to the curved display region 126 by determining a current context of the mobile device.

In some example embodiments, a user may click one of the icons 231, 232, 233 and 234 displayed at the curved display region 126 to execute an application program corresponding to the clicked icon. In other example embodiments, as illustrated in FIG. 10, the user may drag or throw the icon 235 from the curved display region 126 to the flat display region 121 to execute an application program corresponding to the icon 235.

In some example embodiments, as illustrated in FIG. 11, the user may drag or throw an application program executed and displayed at the flat display region 121 to the curved display region 126 to switch the executed application program to a background program having no displayed window. In other example embodiments, by leaning the mobile device 100 that was previously horizontally disposed, the executed application program may be switched to the background program.

As described above, a user interface suitable for the mobile device including the flat display region 121 and the curved display region 126 may be provided. The user interface may include displaying the icons at the curved display region 126. The user interface may further include dragging an icon from the curved display region 126 to the flat display region 121 to execute an application program corresponding to the icon. The user interface may further include dragging an executed application program from the flat display region 121 to the curved display region 126 to switch the executed application program to a background program.

The present embodiments may be applied to any display device including a flat display region and a curved display region, and to any mobile device including the display device. For example, the present embodiments may be applied to the mobile device, such as a mobile phone, a smart phone, a laptop computer, a tablet computer, a personal digital assistants (PDA), a portable multimedia player (PMP), a digital camera, a music player, a portable game console, a navigation device, etc.

The foregoing is illustrative of example embodiments, and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of example embodiments and is not to be construed as limited to the specific embodiments disclosed, and that modifications to the disclosed example embodiments, as well as other example embodiments, are intended to be included within the scope of the appended claims. The inventive concept is defined by the following claims, with equivalents of the claims to be included therein.

What is claimed is:

1. A mobile device, comprising:
a display device including a flat display region having a flat shape and a curved display region having a curved shape, the curved display region being integrally formed with the flat display region;
a sensing unit configured to detect a physical state of the mobile device;
a context determining unit configured to determine a current context of the mobile device based on the physical state detected by the sensing unit, and to select one of the flat display region and the curved display region to be activated based on the current context; and
a display controller configured to activate the selected one of the flat display region and the curved display region.

2. The mobile device of claim 1, wherein the physical state detected by the sensing unit includes at least one of a posture, a position, an azimuth, a movement, incident light, a proximity of an object, an altitude and a motion of the mobile device.

3. The mobile device of claim 1, wherein the sensing unit includes at least one of a gyroscope, a geo-magnetic sensor, an accelerometer sensor, a gravity sensor, a light sensor, a proximity sensor, an altimeter, a motion recognition sensor, a digital compass, a camera and a touch sensor.

4. The mobile device of claim 1, wherein the context determining unit comprises:
a sensing result storing unit configured to receive a sensing result from at least one sensor included in the sensing unit, and to store the sensing result as the physical state;
a context table configured to store a plurality of contexts respectively corresponding to a plurality of sensing results; and
a display region selecting unit configured to select the current context corresponding to the sensing result stored in the sensing result storing unit among the plurality of contexts stored in the context table, and to select the one of the flat display region and the curved display region to be activated based on the current context.

5. The mobile device of claim 4, wherein the display region selecting unit is further configured to receive a logical state of the mobile device from an application processor included in the mobile device, and to select the one of the flat display region and the curved display region to be activated based on the current context and the logical state.

6. The mobile device of claim 5, wherein the logical state of the mobile device includes at least one of an operating mode, an execution of an application and an occurrence of an event of the mobile device.

7. The mobile device of claim 5, wherein the display region selecting unit is further configured to receive a user setting, and to select the one of the flat display region and the curved display region to be activated based on the current context, the logical state and the user setting.

8. The mobile device of claim 7, wherein the user setting includes an automatic selection or a manual selection for the one of the flat display region and the curved display region to be activated.

9. The mobile device of claim 1, wherein, when the sensing unit detects, as the physical state of the mobile device, that the mobile device is vertically disposed and that a proximity of an object is sensed at the flat display region, the context determining unit determines, as the current context of the mobile device, that the mobile device is disposed in a pocket of a dress shirt, and selects the curved display region as a display region to be activated.

10. The mobile device of claim 1, wherein, when the sensing unit detects, as the physical state of the mobile device, that the mobile device is horizontally disposed and that the mobile device is not moving, the context determining unit determines, as the current context of the mobile device, that the mobile device is disposed on a table, and selects the flat display region as a display region to be activated.

11. The mobile device of claim 1, wherein the display controller controls the display device to operate the selected one of the flat display region and the curved display region in an activate mode and to operate the other one of the flat display region and the curved display region in a sleep mode.

12. The mobile device of claim 1, wherein a curvature of the curved display region is adjusted according to a user setting.

13. The mobile device of claim 1, wherein a ratio of a size of the flat display region to a size of the curved display region is adjusted according to a user setting.

14. A method of operating a mobile device including a display device, the display device comprising a flat display region having a flat shape and a curved display region having a curved shape, the curved display region being integrally formed with the flat display region, the method comprising:
detecting a physical state of the mobile device;
determining a current context of the mobile device based on the detected physical state; and
selectively activating one of the flat display region and the curved display region based on the current context.

15. The method of claim 14, further comprising:
detecting a logical state of the mobile device,
wherein the selective activation of the one of the flat display region and the curved display region is performed based on the current context and the logical state.

16. The method of claim 15, further comprising:
receiving a user setting of the mobile device,
wherein the selective activation of the one of the flat display region and the curved display region is performed based on the current context, the logical state and the user setting.

17. The method of claim 14, wherein, when that the mobile device is vertically disposed and that a proximity of an object is sensed at the flat display region are detected as the physical state of the mobile device, that the mobile device is disposed in a pocket of a dress shirt is determined as the current context of the mobile device, and the curved display region is activated.

18. The method of claim 14, wherein, when that the mobile device is horizontally disposed and that the mobile device is not moving are detected as the physical state of the mobile device, that the mobile device is disposed on a table is determined as the current context of the mobile device, and the flat display region is activated.

19. The method of claim 14, wherein the selective activation of the one of the flat display region and the curved display region based on the current context comprises:
selecting the one of the flat display region and the curved display region to be activated based on the current context;
operating the selected one of the flat display region and the curved display region in an activate mode; and
operating the other one of the flat display region and the curved display region in a sleep mode.
